(19) United States
(12) Patent Application Publication
(10) Pub. No.: US 2021/0205970 A1
(43) Pub. Date: Jul. 8, 2021

(54) SOLENOID-POWERED STAPLER

(71) Applicant: ACCO Brands Corporation, Lake Zurich, IL (US)

(72) Inventors: Dominic Menoni, Lake Zurich, IL (US); Dake Wang, Shanghai (CN); Paul Lesiakowski, Palatine, IL (US); Frank A. Pistorio, Itasca, IL (US)

(21) Appl. No.: 17/142,444

(22) Filed: Jan. 6, 2021

Related U.S. Application Data
(60) Provisional application No. 62/957,596, filed on Jan. 6, 2020.

(51) Int. Cl. B25C 5/02; B25C 5/15

(52) U.S. Cl. CPC B25C 5/0228; B25C 5/15

(57) ABSTRACT

A desktop stapler includes a base portion and a lever assembly pivotally coupled to the base portion at a pivot point. A gap is defined between the base portion and a distal end of the lever assembly opposite the pivot point. A biasing member is coupled to the lever assembly and biases the lever assembly away from the base portion. A first solenoid is operable to move the lever assembly relative to the base portion to decrease the gap. A second solenoid is operable to drive a staple from the lever assembly. A controller is programmed to sequentially actuate the first solenoid and the second solenoid.

### CROSS-REFERENCE TO RELATED APPLICATIONS

This application claims priority to U.S. Provisional Patent Application No. 62/957,596 filed Jan. 6, 2020, the entire contents of which are incorporated by reference.

### BACKGROUND

The present invention relates to staplers, and specifically to desktop staplers.

Desktop staplers are typically used in office and home settings to staple two or more sheets of paper together. Electric desktop staplers are known and can provide improved stapling functionality over manual staplers, especially when large stacks of sheets are stapled. One style of electric stapler utilizes a solenoid to drive staples from the stapler. Solenoid-driven staplers provide excellent driving force to enable quality stapling of large stacks of sheets. However, the electric solenoids can be loud.

### SUMMARY

The present invention provides an improved solenoid-driven stapler in which the overall noise emanating from the stapler is reduced, and in which improved stapling performance can be achieved as compared to prior art solenoid-driven staplers.

In one aspect, the invention provides a desktop stapler including a base portion and a lever assembly pivotally coupled to the base portion at a pivot point. A gap is defined between the base portion and a distal end of the lever assembly opposite the pivot point. A biasing member is coupled to the lever assembly and biases the lever assembly away from the base portion. A first solenoid is operable to move the lever assembly relative to the base portion to decrease the gap. A second solenoid is operable to drive a staple from the lever assembly. A controller is programmed to sequentially actuate the first solenoid and the second solenoid.

In another aspect, the invention provides a method of actuating a desktop stapler. The method includes biasing a lever assembly relative to a base portion such that a gap is defined between a distal end of the lever assembly and the base portion, actuating a first solenoid to move the lever assembly relative to the base portion to decrease the gap, waiting a predetermined amount of time, and after the predetermined amount of time, actuating a second solenoid to drive a staple from the lever assembly.

Other aspects of the invention will become apparent by consideration of the detailed description and accompanying drawings.

### BRIEF DESCRIPTION OF THE DRAWINGS

FIG. 1 is a section view of an electric stapler according to one construction of the invention, shown in a rest position.

FIG. 2 is a section view similar to FIG. 1 illustrating the stapler after actuation of a first solenoid.

FIG. 3 is a section view similar to FIG. 2 illustrating the stapler after actuation of a second solenoid.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

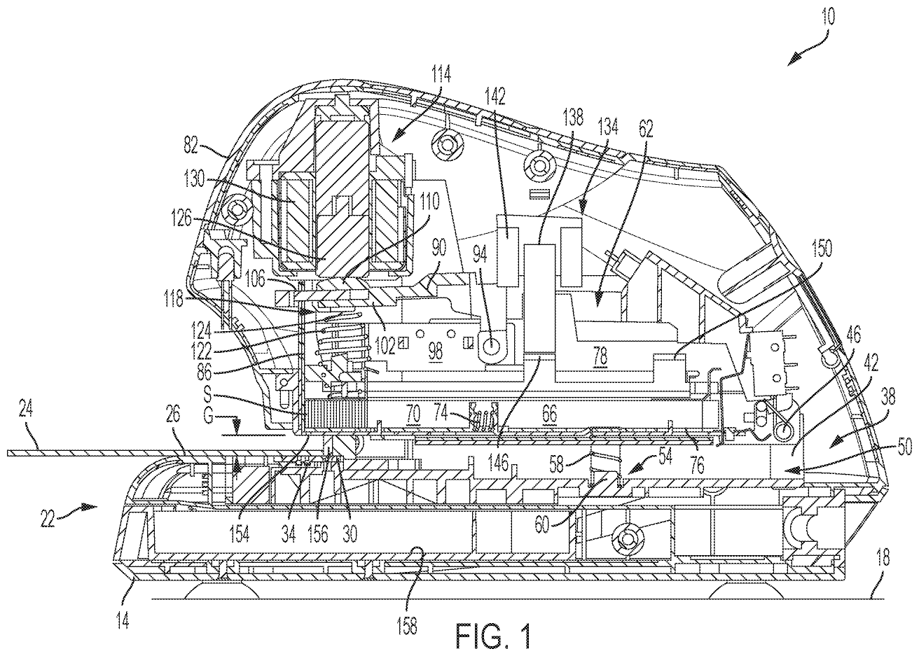

FIGS. 1-3 illustrate an electric, solenoid-driven stapler 10 according to the present invention. The stapler 10 can be powered by an AC and/or a DC power supply. The stapler 10 is sized and configured for use as a desktop stapler. However, the stapler 10 may have various sizes and shapes, and may be used for purposes other than a desktop stapler.

With reference to FIGS. 1-3, the stapler 10 includes a base portion 14 sized and configured to rest on a flat surface 18. The base portion 14 includes a first region 22 disposed at a front of the base portion 14 for receiving a stack of material or sheets 24 (e.g., two or more sheets of paper—see FIG. 1). The first region 22 includes a generally flat, upper surface 26 to support the stack of sheets 24, as well as an anvil 30. The anvil 30 includes at least one grooved area or well 34 for receiving ends of a staple S that have passed through the stack of sheets 24, and for clinching the ends of the staple S together to secure the staple S to the stack of sheets 24.

With continued reference to FIGS. 1-3, the base portion 14 includes a second region 38 disposed at a back of the base portion 14 for pivotally engaging one or more components of the stapler 10. The second region 38 includes two sidewalls 42 (only one is shown) that extend parallel to one another on opposing sides of the stapler 10. Each sidewall 42 includes an aperture for receiving a pivot pin 46 that pivotally engages the base portion 14 to the one or more components and defines a pivot point for the components on the stapler 10. In other embodiments, the pivot point need not be defined by a pin 46, but instead can be formed in other manners, such as via mating projections and detents formed in the various components. The sidewalls 42 form a receiving area 50 between the sidewalls 42 for receiving the one or more additional components, as well as the pivot pin 46.

The base portion 14 also includes at least one seat 54 for receiving the end of a biasing member 58. The illustrated biasing member 58 is a compression spring, although other constructions include different biasing members 58. The illustrated seat 54 includes a circular post 60 on which the end of the spring 58 is located. In other constructions, the seat 54 may take other forms.

The stapler 10 further includes an arm or lever assembly 62 pivotally coupled to the base portion 14 by the pivot pin 46. The illustrated lever assembly 62 includes and/or supports components of the stapler 10 that operate to eject a staple S. Specifically, the lever assembly 62 includes a magazine 66 that houses and supports staples S in a known manner. A staple pusher 70 is biased forwardly by a pusher spring 74 to urge the staples toward the front of the magazine 66. The biasing member 58 engages a lower surface 76 of the magazine 66 to bias the magazine 66 and the remainder of the lever assembly 62 away from the base portion 14 to the position shown in FIG. 1 (i.e., the rest position).

The lever assembly 62 further includes a frame or case 78 at least partially positioned above the magazine 66. The case 78 supports the magazine 66 while allowing sliding movement of the magazine 66 forwardly from the case 78 and out of a housing 82 that surrounds the lever assembly 62. The illustrated stapler 10 is a front-loading stapler, in which the magazine 66 can extend forwardly out of the housing 82 to permit a user to load staples S into the magazine 66. Front-loading staplers are known, and the details of the mechanism and operation will not be described herein.

The case 78 also pivots about the pivot pin 46 with the magazine 66, and further supports additional components. Specifically, the case 78 supports a staple driver 86 for movement both with and relative to the magazine 66 to drive staples S from the magazine 66. The staple driver 86 is coupled to a driver arm 90 that is pivotally coupled to the case 78 at pivot pin 94, which defines a pivot point for the driver arm 90. The pivot pin 94 is distinct from the pivot pin 46 and is spaced closer to the front of the magazine 66 than the pivot pin 46. The pivot pin 94 is supported between two sidewalls 98 (only one is shown) of the case 78. The driver arm 90 includes a first or bottom side 102 facing downwardly toward the magazine 66, and a second or top side 106 facing upwardly toward the top of the stapler 10. The top side 106 includes an enlarged portion or protrusion 110 that is sized and configured to be engaged by an electric solenoid 114, as will be discussed further below. The bottom side 102 includes a seat 118 sized and configured to receive and support an upper end of a biasing member 122 operable to bias the driver arm 90 away from the magazine 66. The illustrated biasing member 122 is a compression spring, although other constructions include different biasing members 122. The illustrated seat 118 includes a circular post 124 on which the end of the spring 122 is located. In other constructions, the seat 118 may take other forms. The lower end of the spring 122 abuts the case 78, which can also include a seat (not shown) designed to facilitate placement and retention of the spring 122.

The solenoid 114 is supported within the housing 82 to be positioned as shown above the lever assembly 62. The solenoid 114 is of a conventional design in which a plunger 126 is driven axially (downwardly as shown in the figures) upon energization of the coil 130. The downward movement of the plunger 126 ultimately causes the driver arm 90 to pivot about the pivot pin 96 (in a counter-clockwise direction in the figures), overcoming the biasing force of the spring 122 (i.e., compressing the spring 122), so that the staple driver 86 will move downwardly within and relative to the magazine 66 to drive a staple S out of the magazine 66 and into a stack of sheets 24 (e.g., up to 20 sheets, up to 40 sheets, up to 60 sheets). After the actuation, when the solenoid 114 is no longer energized, the spring 122 returns the driver arm 90, and therefore the staple driver 86, back to the rest position shown in FIG. 1. In alternative embodiments, the driver arm 90 can be eliminated and the plunger 126 may act directly on the staple driver 86. In such instances, the spring 122 may bias the staple driver 86 upwardly in other manners.

Conventional solenoid-driven staplers are noisy during operation, and sometimes experience inconsistent results during low-sheet-count stapling. Noise levels are elevated due to the high speed and large force exerted by the plunger. When the plunger rapidly presses against the driver arm (or the driver blade), the lever assembly rapidly pivots downwardly, smashing the bottom of the magazine against the stack of sheets with a high level of force. This “impact noise” adds to the noise already created by the actuation of the solenoid. Additionally, where the number of sheets being stapled is low, the rapid action of the plunger may actually cause the staple driver to drive a staple out of the magazine before the magazine engages and clamps down on the stack of sheets. This can result in poor or incomplete stapling.

To provide a solenoid stapler with reduced noise, and with improved stapling performance, the stapler 10 includes another solenoid 134 that is separate and distinct from the solenoid 114. In other words, the stapler includes two solenoids 114, 134, each solenoid operable to complete only a portion of the overall stapling action. As shown in FIGS. 1-3, the solenoid 134 is also supported within the housing 82 and is located rearwardly of the solenoid 114, toward the pivot pin 46. In other words the solenoid 134 is positioned between the solenoid 114 and the pivot pin 46. The solenoid 134 is also of a conventional design in which a plunger 138 is driven axially (downwardly as shown in the figures) upon energization of the coil 142. The plunger 138 engages a feature of the case 78, such as a flange 146 that is positioned near a central portion of the case 78 and the magazine 66 (i.e., near the midpoint between the front and the rear ends of the magazine 66). This engagement drives the pivotal movement of the lever assembly 62, as will be described in detail below. The illustrated case 78 also includes a second flange 150 located further to the rear than the flange 146. In other embodiments, and depending upon the amount of space available within the housing 82, the solenoid 134 could be positioned so that the plunger 138 engages the second flange 150. In yet other embodiments, the solenoid 134 could engage other features on the case 78 and/or the magazine 66 to allow the solenoid 134 to move the lever assembly 62.

The stapling operation of the stapler 10 will now be described. Referring first to FIG. 1, a user first inserts a stack of sheets 24 into the throat or gap G defined between the upper surface 26 of the base portion 14 (e.g., at the anvil 30) and the lower surface 76 of the magazine 66 (e.g., at the opening 154 in the lower surface 76 where the staples S are ejected). The illustrated stapler 10 includes an automatic trigger arrangement or sensor 156 that senses the insertion of the stack of sheets 24 (e.g., mechanically, optically, etc.) and automatically signals the stapler's controller 158 to initiate the stapling operation. The illustrated trigger arrangement 156 may be part of a throat depth guide operable to selectively set the allowed insertion depth of the stack of sheets 24 in the throat. In other embodiments, the stapling operation may not be automatic, but rather may be manually initiated by a user depressing a button.

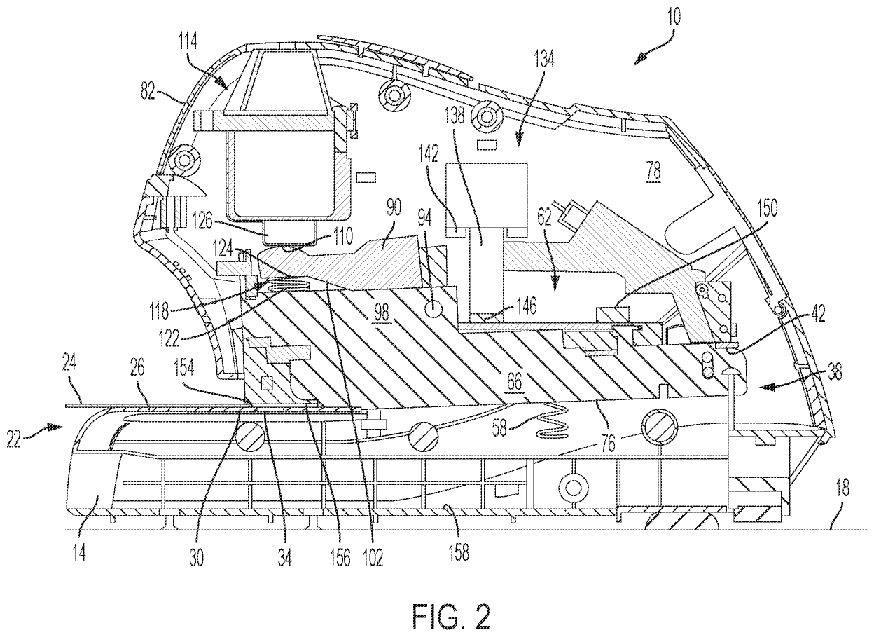

Upon the triggering of the stapling operation, the stapler's logic first actuates the solenoid 134 (hereinafter referred to as “the first solenoid 134” due to the order in which it is actuated). The actuation of the first solenoid 134 causes the plunger 138 to engage the flange 146 with a downward force that is just sufficient to overcome the bias of the spring 58 (i.e., compressing the spring 58). This force causes the lever assembly 62, including the magazine 66, to pivot about the pivot point defined by the pivot pin 46 so that the lower surface 76 of the magazine 66 gently engages the stack of sheets 24 previously inserted into the throat (see FIG. 2). The gap G is reduced in size from the rest position shown in FIG. 1 to the position shown in FIG. 2, in which the magazine 66 engages the stack of sheets 24. The gentle engagement results in less impact noise than that observed when a staple-driving solenoid also induces the clamping motion of the magazine. The net force applied from the first solenoid 134, against the bias of the spring 58, through the magazine 66, and on the stack 24 is minimized (approaching 0 Newtons) while ensuring that there is engagement with the stack 24. Therefore, the force applied by the first solenoid 134 is great enough to engage a minimum number of sheets 24 (e.g., 1 sheet, 2 sheets) with a minimized engagement force. The engagement force increases slightly with a thicker stack of sheets 24 (e.g., up to a 3 Newton net force, up to a 5 Newton net force), though would still be substantially less than the force required to drive a staple.

The first solenoid 134 can be selected so that it exerts only the force necessary to overcome the bias of the spring 58, thereby enabling the rapid, yet gentle, clamping or engagement of the magazine 66 on the stack of inserted sheets. The first solenoid 134 does not provide any part in driving a staple S. The selection of the first solenoid 134 and the spring 58 can be optimized depending upon the particular stapler. In the illustrated embodiment, the first solenoid 134 is a McMaster Carr linear solenoid, part no. 70155K112 (12 Volt), with a 0.5 inch stroke and 26 oz. force, available from McMaster Carr of Elmhurst, Ill. The spring 58 is an 8.0 millimeter compression spring having a wire diameter of 0.8 millimeters, a coil spacing of 2.0 millimeters, and a spring load of 25.5±1 Newtons. The total time required to actuate the first solenoid to engage the magazine 66 with the stack of sheets 24 may be less than 500 milliseconds (e.g., between 200-400 milliseconds, 300 milliseconds).

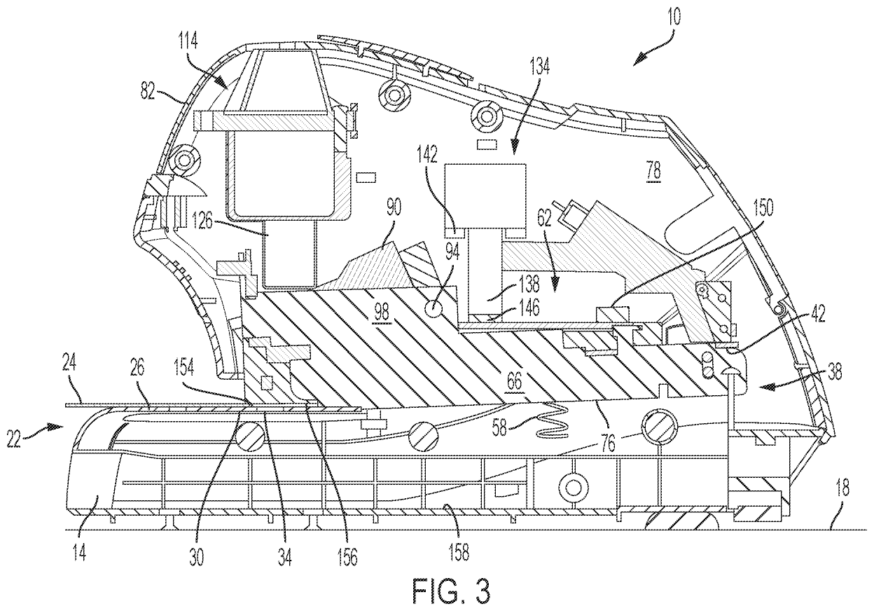

After actuation of the first solenoid 134, the stapler logic waits for a predetermined amount of time, which in the illustrated embodiment is less than 0.1 seconds, and preferably is between 0.008 and 0.050 seconds, and in one embodiment, is 0.025 seconds. After waiting for the predetermined amount of time to ensure the magazine 66 has engaged the stack of sheets 24, the stapler logic then proceeds to sequentially actuate the solenoid 114 (hereinafter referred to as “the second solenoid 114” due to the order in which it is actuated). The first solenoid 134 may remain energized to hold the magazine 66 into engagement with the stack of sheets 24, and actuation of the second solenoid 114 then occurs to initiate the driving of the staple S from the magazine 66. Actuation of the second solenoid 114 may also act to increase the clamping force exerted by the magazine 66 on the stack of clamped sheets. Alternatively, the first solenoid 134 may be de-energized once the second solenoid 114 is energized. Energization of the second solenoid 114 causes the plunger 126 to exert a downward force on the protrusion 110 of the driver arm 90 to pivot the driver arm 90 about the pivot pin 96 (in a counter-clockwise direction in the figures). The force exerted by the second solenoid 114 overcomes the biasing force of the spring 122 so that the staple driver 86 moves downwardly within and relative to the magazine 66 with sufficient force to drive a staple S out of the magazine 66 and into a stack the sheets (see FIG. 3). The actuation of the first solenoid 134 ensures that the magazine 66 is engaged with the stack of sheets 24 when the staple is ejected from the magazine 66, thereby ensuring that the staple is properly guided and driven into the stack of sheets 24. This provides improved stapling consistency over prior art solenoid-driven staplers utilizing only a single solenoid.

The stapler 10 includes the controller 158 for implementing the above-discussed stapler logic. The controller 158 operates using code that is programmed to achieve the desired operability discussed above, including the desired delay time between the first and second solenoid actuations.

In the illustrated embodiment, the second solenoid 114 is a Global Point Magnetics linear solenoid, part no. GPM3828C-01 (110 Volt), capable of penetrating through a 40-sheet stack of paper, available from Global Point Magnetics Asia Co. of Guangdong P.R.C. The spring 122 is a 27 millimeter compression spring having a wire diameter of 1.1 millimeters, a coil spacing of 3.0 millimeters and a spring load of 30±1.5 Newtons. This second solenoid 114 has a much higher maximum force output capacity than the first solenoid 134 since it must be able to drive the staple S. The first solenoid 134 can have a much lower maximum force output capacity because it does not in any way directly contribute to the driving of the staple S from within the magazine 66.

After the staple S is driven, the first and second solenoids 114, 134 are de-energized by the controller 158 and the springs 58 and 122 return the lever assembly 62 and the driver arm 90 to their respective rest positions (see FIG. 1). The stapler 10 is then ready for the next stapling operation.

Testing has revealed that the stapler 10 produces a much lower noise output than conventional solenoid-driven staplers on the market today. In tests conducted when stapling only two sheets, the following results were observed under similar testing conditions. Decibel levels were measures from a distance of 24 inches away from the stapler, with the staplers placed on a granite surface to eliminate unwanted resonance and vibrations from external sources.

| | Decibel Level - | Decibel Level - |
|---|---|---|
| Stapler | dB(A) | dB(C) |
| Bostich B8 Impulse 45 | 88 | 89.1 |
| Inventive Stapler 10 | 67.1 | 68.3 |

In fact, the noise levels observed for the stapler 10 approached noise levels of a Swingline Optima 45GD gear-driven stapler, which does not utilize a solenoid. That gear-driven stapler registered noise readings of 64.4 dB(A) and 68 dB(C). As such, the stapler 10 enjoys reduced noise in relation to other solenoid-driven staplers, while costing less than the more expensive, yet quieter gear-driven electric staplers.

Various features and advantages of the invention are set forth in the following claims.

1. A desktop stapler comprising:
a base portion;
a lever assembly pivotally coupled to the base portion at a pivot point, a gap defined between the base portion and a distal end of the lever assembly opposite the pivot point;
a biasing member coupled to the lever assembly that biases the lever assembly away from the base portion;
a first solenoid operable to move the lever assembly relative to the base portion to decrease the gap;
a second solenoid operable to drive a staple from the lever assembly; and
a controller programmed to sequentially actuate the first solenoid and the second solenoid.

2. The desktop stapler of claim 1, wherein the first solenoid is positioned between the second solenoid and the pivot point.

3. The desktop stapler of claim 1, wherein the lever assembly includes a magazine sized and configured to hold staples.

4. The desktop stapler of claim 1, wherein the biasing member is a compression spring positioned between the lever assembly and the base portion.

5. The desktop stapler of claim 1, wherein the biasing member is a first biasing member, and the desktop stapler further includes a second biasing member positioned between the second solenoid and the lever assembly.

6. The desktop stapler of claim 5, wherein the first biasing member is compressible by the first solenoid, and wherein the second biasing member is compressible by the second solenoid.

7. The desktop stapler of claim 1, further comprising a sensor configured to sense one or more sheets inserted into the gap, and wherein the controller is operable to actuate the first and second solenoids in response to a signal from the sensor.

8. The desktop stapler of claim 1, wherein the gap is defined between an opening through which the staple is driven and an anvil on the base portion.

9. The desktop stapler of claim 1, further comprising a housing surrounding the lever assembly and the first and second solenoids.

10. The desktop stapler of claim 1, wherein the first solenoid has a lower maximum output force capacity than the second solenoid.

11. A method of actuating a desktop stapler, the method comprising;
biasing a lever assembly relative to a base portion such that a gap is defined between a distal end of the lever assembly and the base portion;
actuating a first solenoid to move the lever assembly relative to the base portion to decrease the gap;
waiting a predetermined amount of time; and
after the predetermined amount of time, actuating a second solenoid to drive a staple from the lever assembly.

12. The desktop stapler of claim 11, wherein biasing the lever assembly is performed by a spring positioned between the lever assembly and the base portion.

13. The desktop stapler of claim 12, wherein actuating the first solenoid to move the lever assembly relative to the base portion to decrease the gap includes compressing the spring.

14. The desktop stapler of claim 11, wherein actuating the first solenoid to move the lever assembly relative to the base portion engages the lever assembly with a plurality of sheets positioned within the gap.

15. The desktop stapler of claim 11, wherein actuating the second solenoid to drive the staple includes compressing a spring positioned between the second solenoid and the lever assembly.

16. The desktop stapler of claim 11, wherein the predetermined amount of time is at least 0.008 seconds.

17. The desktop stapler of claim 16, wherein the predetermined amount of time is between and includes 0.008 and 0.050 seconds.

18. The desktop stapler of claim 17, wherein the predetermined amount of time is 0.025 seconds.
